(19) United States
(12) Patent Application Publication
(10) Pub. No.: US 2016/0205051 A1
(43) Pub. Date: Jul. 14, 2016

(54) SYSTEM AND METHOD FOR ASSOCIATING MESSAGE WITH OBJECT

(71) Applicant: Artcera Corporation, New Taipei City (TW)

(72) Inventors: Chun-Ming Yu, New Taipei City (TW); Yi-Hsuan Chao, New Taipei City (TW)

(21) Appl. No.: 14/596,166

(22) Filed: Jan. 13, 2015

(51) Int. Cl. H04L 12/58; H04L 29/08; H04W 4/00

(52) U.S. Cl. CPC H04L 51/10; H04W 4/008; H04L 51/38; H04L 67/10

(57) ABSTRACT

The invention is about associating a message with an object. A sender stores a message in a cloud database via a connection device through a short-range wireless means. The connection device is attached to a gift or present. After receiving the gift or present, a receiver reads or downloads the message also through a short-range wireless means. As such, the sender can clearly and fully deliver his/her greeting to the receiver.

### BACKGROUND OF THE INVENTION

(a) Technical Field of the Invention

The present invention is generally related to storing and forwarding messages, and more particular to storing a message in a cloud database and associating the message with a gift or present.

(b) Description of the Prior Art

Conventionally, a note or card is attached to a gift or present so that a receiver can recognize who the sender is, and the sender can record his/her greetings or wishes towards the receiver. In the computer age, some people would, instead of notes or cards, attach a media storage device to the gift where recorded audio and/or video messages are stored.

The above conventional method of associating message with a gift suffers the following problems.

Firstly, notes or cards cannot fully convey the sender's intention.

Secondly, media storage devices are costly, and the receivers have to locate playback devices so as to listen or view the content stored in the media storage devices.

Additionally, sometimes the cards or the media storage devices cannot be attached to the gifts or presents satisfactorily due to their incompatible dimensions.

### SUMMARY OF THE INVENTION

The present invention provides a method and system for associating a message with an object. According to the present invention, a sender stores a message in a cloud database through a connection device over a short-range wireless means. The connection device is attached to the object (e.g., a gift or present). A receiver reads or downloads the message also through a connection device over a short-range wireless means.

The method contains the following steps: (a) a sender attaching a connection device to the object; (b) the sender entering the message on a first electronic device; (c) the first electronic device delivering the message to a message unit of the connection device via a short-range wireless means; (d) the message unit storing the message onto a cloud database; (e) after the object is offered to a receiver, a second electronic device communicating with the message unit via a short-range wireless means and data-linking with the cloud database; and (f) the second electronic device reading the message from the cloud database and displaying the message to the receiver.

With the present invention, the sender can fully and clearly deliver his/her greetings to the receiver, thereby obviating the shortcomings such as that notes or cards cannot fully convey the sender's intention, that the cards or the media storage devices cannot be attached to the gifts or presents satisfactorily due to their incompatible dimensions, and that it is inconvenient to play the content of the media storage device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional diagram showing a system according to the present invention.

FIG. 2 is flow diagram showing the step of a method according to the present invention.

FIG. 3 shows a connection device attached to an object according to the present invention.

FIG. 4 shows a message being entered to a first electronic device according to the present invention.

FIG. 5 shows a message being stored onto a cloud database according to the present invention.

FIG. 6 shows a message being retrieved from a cloud database according to the present invention.

FIG. 7 shows a message composing module activated to enter a message according to the present invention.

FIG. 8 shows a message being stored onto a cloud database according to the present invention.

FIG. 9 shows an application scenario of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

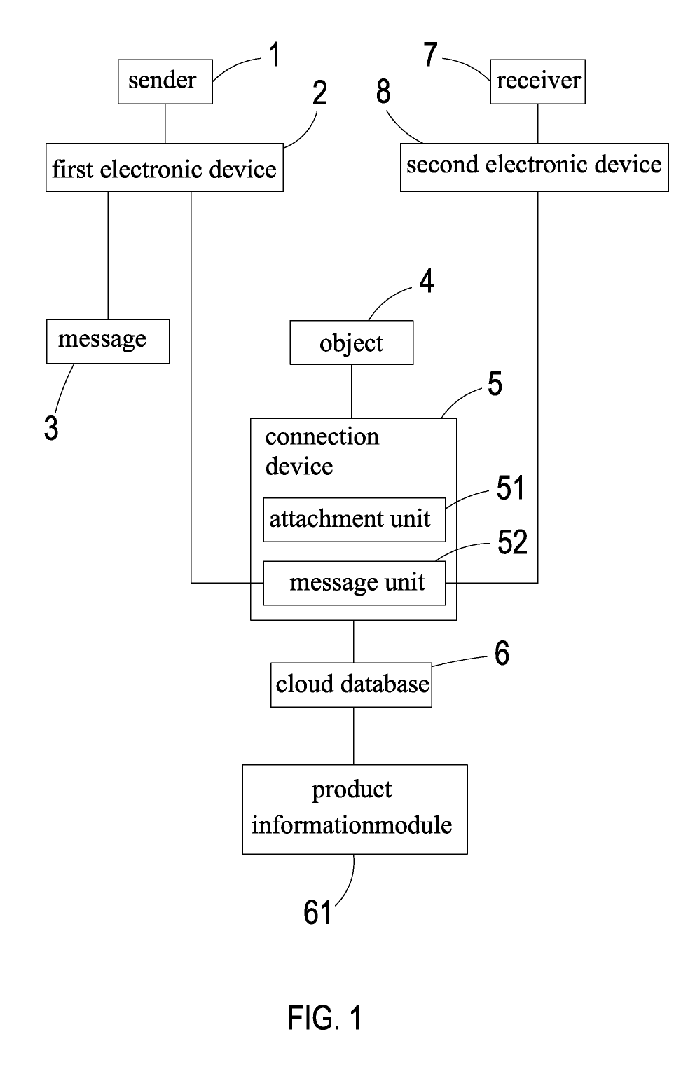

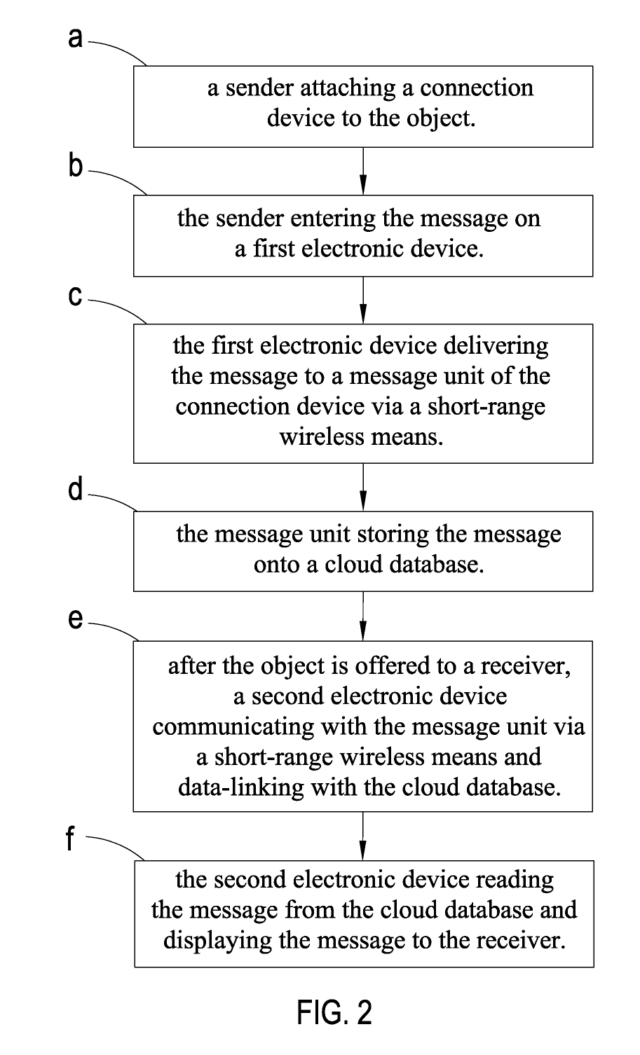

As shown in FIGS. 1 and 2, a system for associating a message with an object according to the present invention contains the following components.

There is at least a first electronic device 2 for a sender 1 to enter a message 3.

There is a connection device 5 associating the message 3 to an object 4 (i.e., a present or a gift). The connection device 5 contains a message unit 52 receiving the message 3 from the first electronic device 2 via a short-range wireless means, and an attachment unit 51 joining the connection device 5 to the object 4.

There is a cloud database 6 linking with the message unit 52 and storing the message 3.

A method for associating a message with an object according to the present invention contains the following steps.

In step (a), a connection device 5 is attached to an object 4.

In step (b), a sender 1 enters a message 3 into a first electronic device 2.

In step (c), the message 3 is delivered to a message unit 52 of the connection device 5 via a short-range wireless means.

In step (d), the message unit 52 stores the message 3 onto a cloud database 6.

In step (e), after the object 4 is offered to a receiver 7, a second electronic device 8 is communicated with the message unit 52 via a short-range wireless means and is data-linked with the cloud database 6.

In step (f), the message 3 is read from the cloud database 6 by and displayed on the second electronic device 8.

In the above steps, the step (a) can be conducted between steps (b) and (c), or between steps (c) and (d). In other words, the sender 1 can attach the connection device 5 to the object 4 after entering the message 3, or after the message 3 is stored onto the cloud database 6. The present invention does not impost specific sequence among these steps.

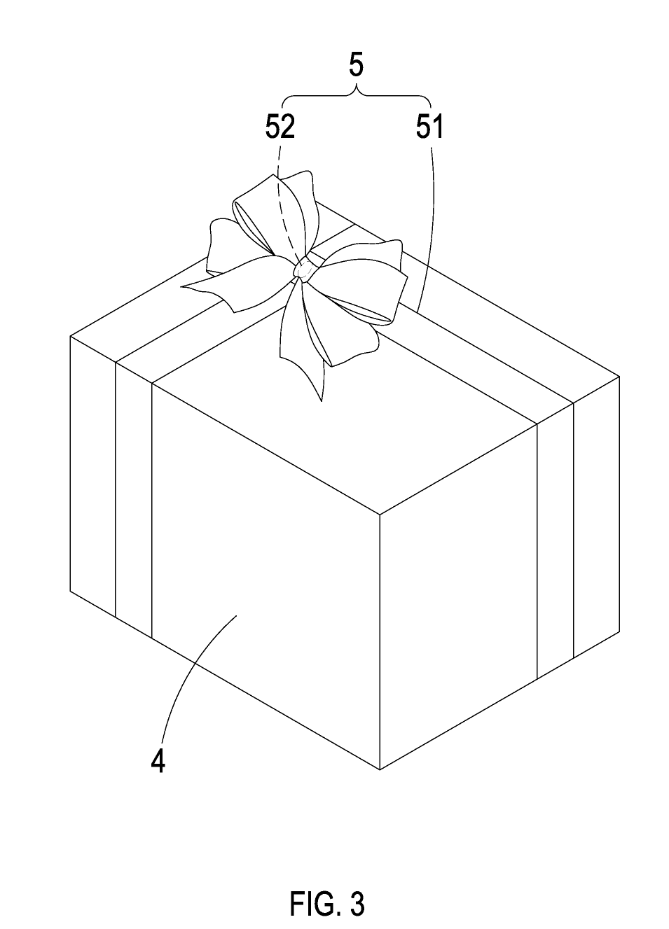

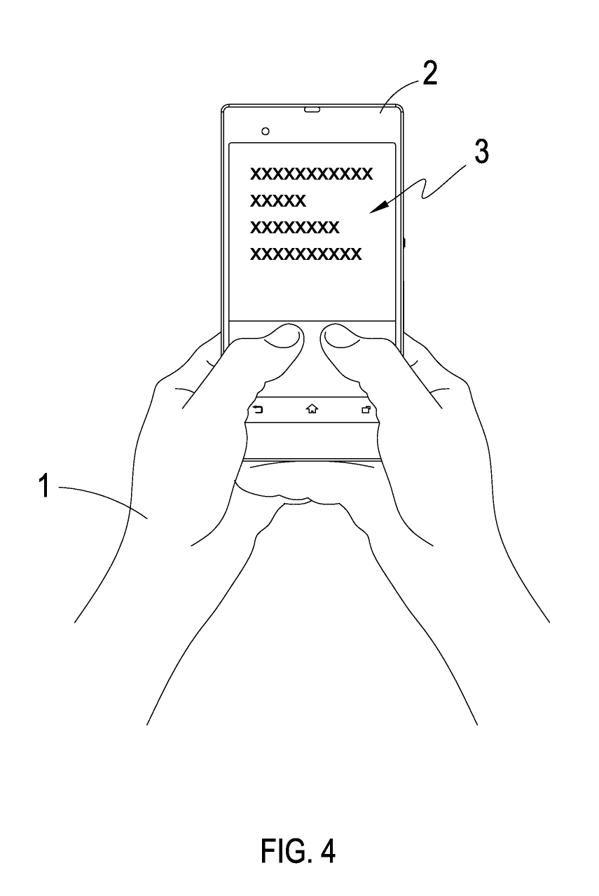

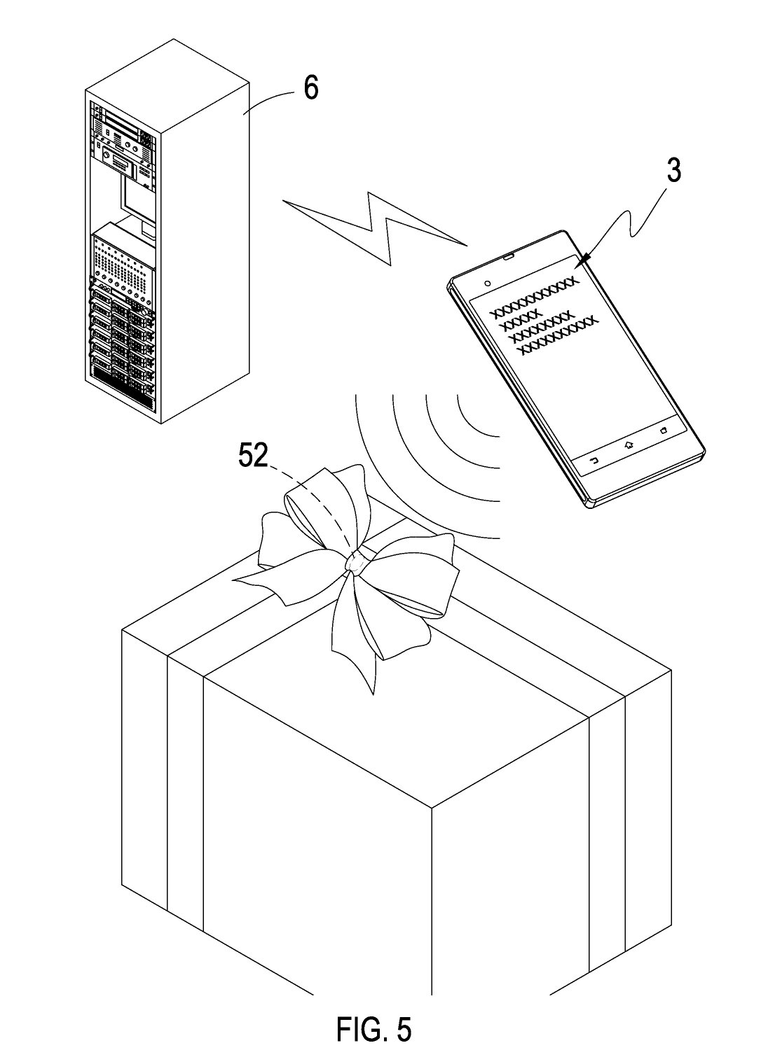

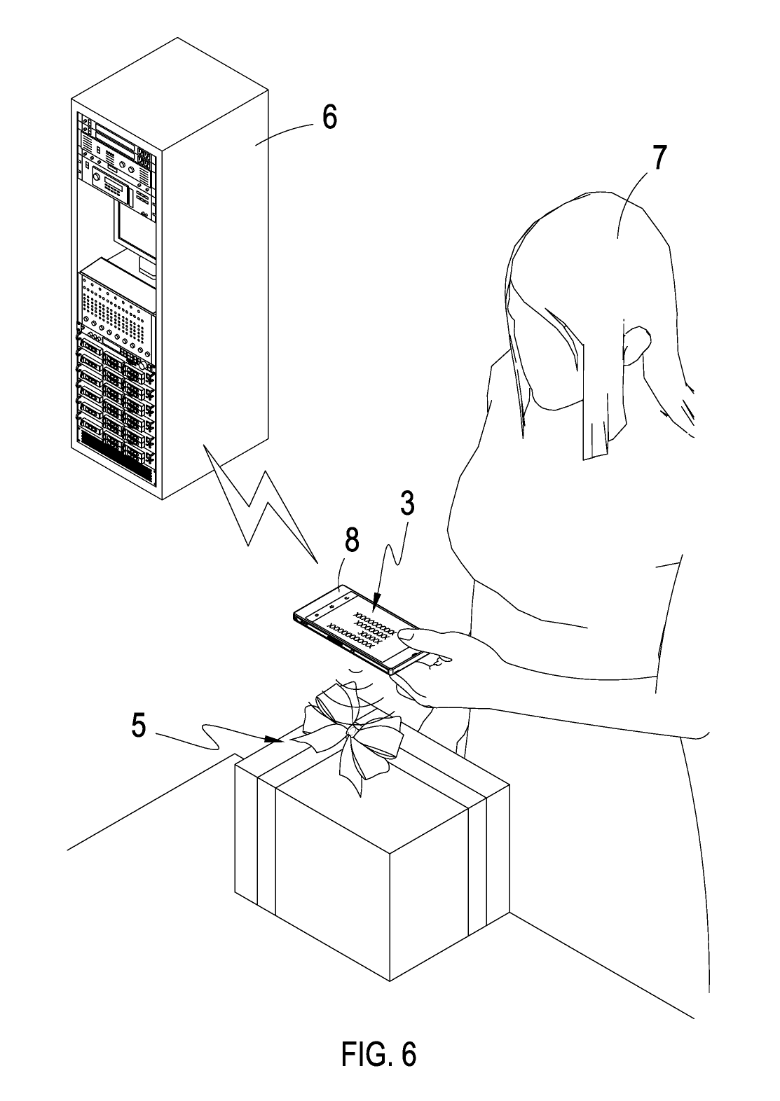

As shown in FIGS. 1 to 6, the sender 1 can enter text, pictures, a segment of audio recording, a video clip, and produce the message 3 using the first electronic device 2. Then, depending on the object 4, the connection device 5 can be physically joined to the object 4 through the attachment unit 51 by adhesion, fastening, wrapping, binding, hanging, placement, adsorbing, etc. The first electronic device 2 communicates with the message unit 52 through a short-range wireless means so that the message 3 is stored in the cloud database 6. The receiver 7, after receiving the object 4, uses the second electronic device 8 to communicate with the message unit 52 through a short-range wireless means. The message 3 is read from the cloud database 6 and displayed on the second electronic device 8 for the receiver 7 to view or download. In addition, the receiver 7 can also browse information about the object 4 such as its serial number, product category, product certificates, production time, delivery time, etc. by connecting to a product information module 61 of the cloud database 6 via the message unit 52.

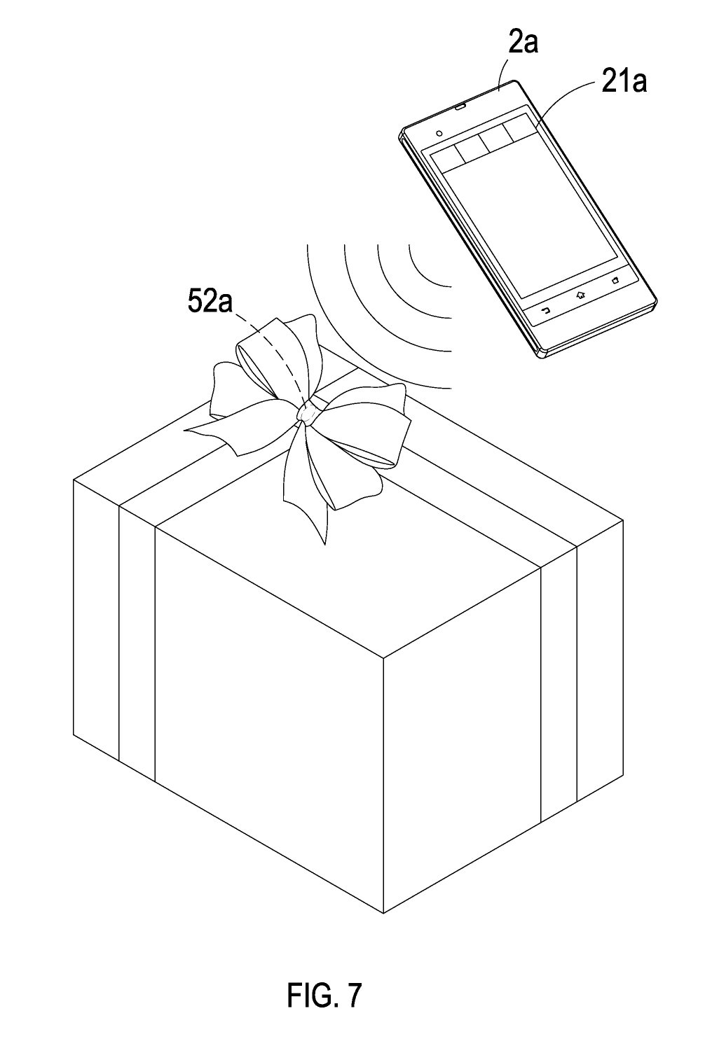

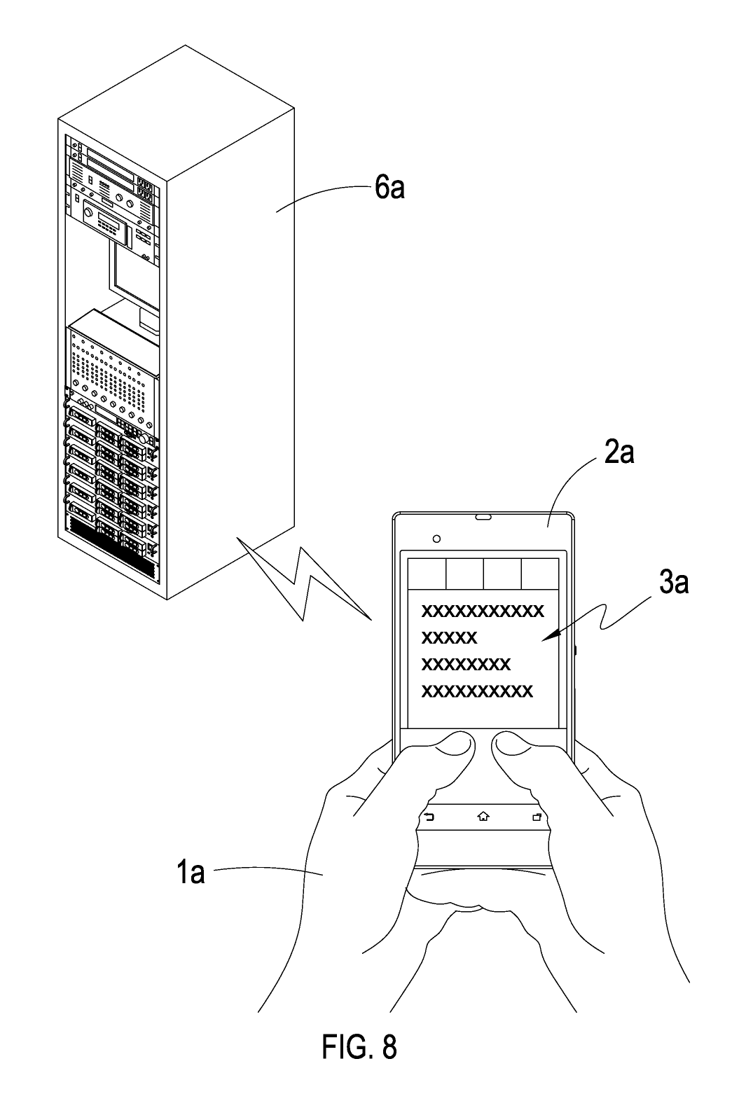

As shown in FIGS. 7 and 8, in an embodiment of the present invention, the first electronic device 2a contains a message composing module 21a which can be a mobile communication program (e.g., app). When the sender 1a uses the first electronic device 2a to link the message unit 52a via the short-range wireless means, the message composing module 21a is activated and presented on a display of the first electronic device 2a so that the sender 1a can edit the message 3a. The message 3a can contain text, pictures, a segment of audio recording, a video clip, etc. After composing the message 3a, the message 3a is stored in the cloud database 6a. The rest of the details are identical what is described above.

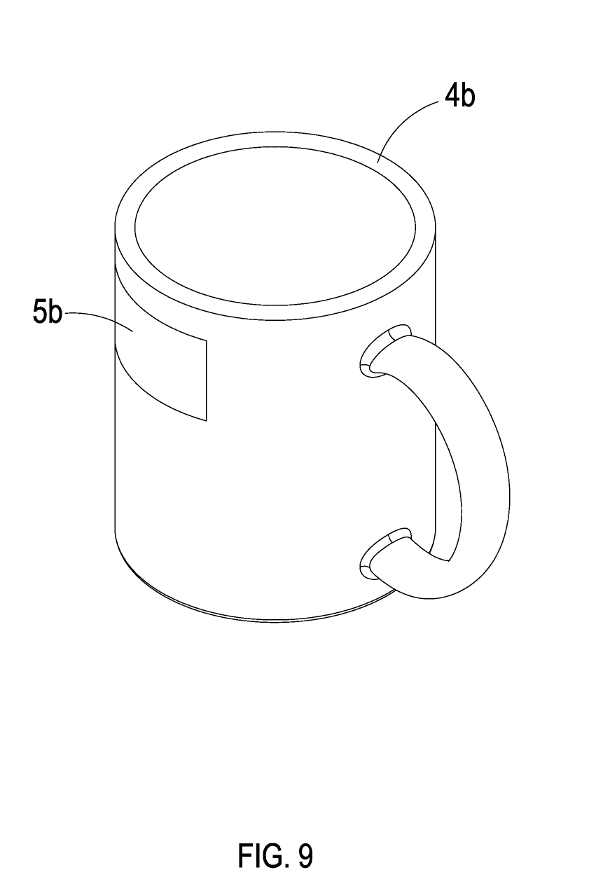

As shown in FIG. 9, the object 4b is a mug and the connection device 5b is adhered to a circumference of the mug. The object can also be a ceramic or porcelain container or art work.

The short-range wireless means can be Near Field Communication (NFC) or RFID.

The advantages of the present invention are as follows.

Firstly, the sender can clearly and fully deliver his/her greeting to the receiver through a multimedia message which contains text, pictures, audio and video clips.

Secondly, the message can be easily associated with the gift or present of any kind.

Thirdly, using NFC or RFID, the operation is simple and convenient.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for associating a message with an object, comprising the steps of:
(a) a sender attaching a connection device to the object;
(b) the sender entering the message on a first electronic device;
(c) the first electronic device delivering the message to a message unit of the connection device via a short-range wireless means;
(d) the message unit storing the message onto a cloud database;
(e) after the object is offered to a receiver, a second electronic device communicating with the message unit via a short-range wireless means and data-linking with the cloud database; and
(f) the second electronic device reading the message from the cloud database and displaying the message to the receiver.

2. The method according to claim 1, wherein the connection device further comprises an attachment unit; and the connection device is physically joined to the object by the attachment unit.

3. The method according to claim 2, wherein the connection device is physically joined to the object by one of the following means: adhesion, fastening, wrapping, binding, hanging, placement, and adsorbing.

4. The method according to claim 1, wherein the first electronic device comprises a message composing module for entering the message;
and the message composing module is activated when the first electronic device is linked with the message unit by the short-range wireless means.

5. The method according to claim 1, wherein the object is a ceramic or porcelain container or art work.

6. The method according to claim 1, wherein the step (a) is conducted between steps (b) and (c), or between steps (c) and (d).

7. The method according to claim 1, further comprising the step:
(g) the second electronic device downloading related information of the object from the cloud database and displaying the information to the receiver.

8. A system for associating a message with an object, comprising:
a first electronic device for a sender to enter the message;
a connection device associating the message to the object, the connection device comprising a message unit receiving the message from the first electronic device via a short-range wireless means, and an attachment unit joining the connection device to the object;
a cloud database linking with the message unit and storing the message; and
a second electronic device communicating with the message unit via a short-range wireless means and data-linking with the cloud database for reading or downloading the message.

9. The system according to claim 8, wherein the first electronic device comprises a message composing module for entering the message.

10. The system according to claim 8, wherein the cloud database comprises a product information module storing related information about the object.
